(19) United States
(12) Patent Application Publication
(10) Pub. No.: US 2002/0198787 A1
(43) Pub. Date: Dec. 26, 2002

(54) Company and college online book ordering system, also known as cobos

(75) Inventor: Sung Woo Yang, Los Angeles, CA (US)

Correspondence Address: CHARLES C.H. WU, 7700 IRVINE CENTER DRIVE, SUITE 710, IRVINE, CA, 92618-3043, US

(73) Assignee: TECHNO MECCA, INC.

(21) Appl. No.: 09/884,350

(22) Filed: Jun. 20, 2001

(51) Int. Cl. G06F 17/60

(52) U.S. Cl. 705/26

(57) ABSTRACT

A method of processing book orders. A vendor establishes a plurality of distribution centers located in different parts of the world, as well as a receiving center. A plurality of customers places book orders. The vendor receives the book orders and sorts them by book sellers. After sorting, the vendor creates aggregated orders and places them with the corresponding book sellers. This provides savings on shipping costs because a publisher or a wholesaler would ship large quantities of books rather than shipping books individually. The aggregated orders are received at the receiving center and sorted by the distribution centers corresponding to the book orders, creating bulk shipments. The bulk shipments are then shipped to the corresponding distribution centers. This provides savings on shipping costs because books are shipped from the receiving center to the distribution centers in large quantities rather than shipping books individually. The book orders are then shipped from the distribution centers to the individual customers.

### FIELD OF THE INVENTION

The present invention relates to a method of processing book orders, and more particularly, aggregating book orders in the way that provides savings on shipping costs.

### BACKGROUND OF THE INVENTION

With the advent of the Internet, more and more consumers are purchasing merchandise on line. This is especially true in the area of book sales. A growing number of companies offer the convenience of searching their on line databases containing thousands of book titles. Such search can be done by a variety of search terms, such as book title, author, subject, ISBN (an International Standard Book Number—a unique number assigned to every book published in the world that is normally printed on a book cover as a bar code), and many others. Upon finding the desired book, a customer would have an option of ordering and paying for the book on line.

However, despite the ease of searching and ordering books via the Internet, the end product of this process, i.e. receiving the purchased book from a vendor, involves shipping of the book to the customer. As persons knowledgeable in the pertinent arts will recognize, shipping is the major expense involved in the book selling business. Minimizing shipping costs dramatically increases the profit margins and provides competitive advantage to the vendors who find ways to minimize shipping costs.

### SUMMARY OF THE INVENTION

An embodiment of the present invention is directed to a method of processing book orders, and more particularly, aggregating book orders in the way that provides savings on shipping costs. A vendor establishes a plurality of distribution centers located in different parts of the world, as well as a receiving center. A plurality of customers places book orders. The vendor receives the book orders and sorts them by book sellers (book sellers may be publishers of the specific books or wholesalers). After sorting, the vendor creates aggregated orders and places them with the corresponding book sellers. This provides savings on shipping and inventory costs because a publisher or a wholesaler would ship large quantities of books rather than shipping books individually. Furthermore, it provides a better on time delivery performance and more informative shipping status information.

The aggregated orders are received at the receiving center and sorted by the distribution centers corresponding to the book orders, creating bulk shipments. The bulk shipments are then shipped to the corresponding distribution centers. Once again, this provides savings on shipping costs because books are shipped from the receiving center to the distribution centers in large quantities rather than shipping books individually. The book orders are then shipped from the distribution centers to the individual customers.

### BRIEF DESCRIPTION OF THE DRAWING FIGURES

FIG. 1 is a flow diagram that illustrates the preferred embodiment of the present invention.

### DETAILED DESCRIPTION OF THE PREFERRED EMBODIMENT

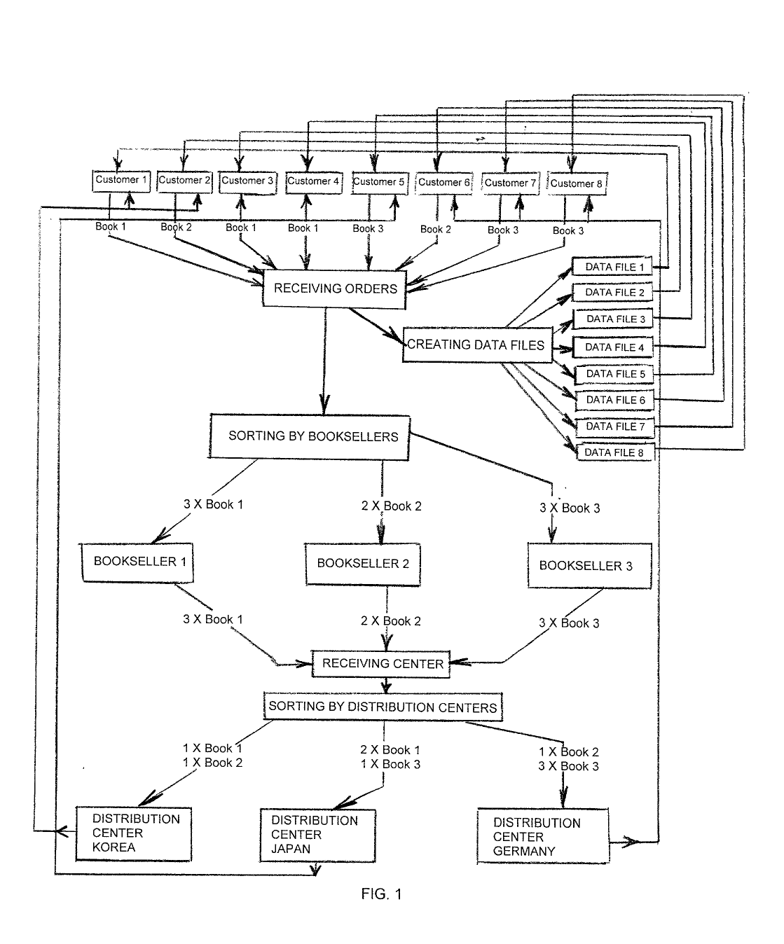

The present invention will be better understood with reference to FIG. 1, which is a flow diagram that illustrates the preferred embodiment of the present invention. Viewing the top of FIG. 1, there shown customers, Customer 1 through Customer 8, whose book orders are processed according to the present invention. For the matter of simplicity, it is assumed that Customer 1 and Customer 2 are located in Korea. Customer 3, Customer 4 and Customer 5 are located in Japan. Customer 7 and Customer 8 are located in Germany.

Viewing the bottom of FIG. 1, there shown distribution centers corresponding to the locations of the above customers, Distribution Center Korea, Distribution Center Japan and Distribution Center Germany. Going back to the top of FIG. 1, it is assumed that Customer 1 desires to purchase Book 1, Customer 2 desires to purchase Book 2, Customer 3 desires to purchase Book 1, Customer 4 desires to purchase Book 1, Customer 5 desires to purchase Book 3, Customer 6 desires to purchase Book 2, Customer 7 desires to purchase Book 3 and Customer 1 desires to purchase Book 3. It should be understood that any number of customers can each order any number of books and this example has eight customers and three books for the sake of simplicity only.

Moving down FIG. 1, Customers 1 through 8 order their respective books and the book orders are received by the vendor. The ordering process, as well as paying for the books, is normally done via the Internet. However, the ordering can be done by telephone or fax. Upon receiving the book orders from Customers 1 through 8, the vendor creates data files for each customer (shown in FIG. 1 as data file 1 through data file 8). A customer purchase order number is assigned to each of said data files. These data files may contain the identifying information about the customer, as well as the information corresponding to each book in the book order, such as an International Standard Book Number (ISBN), the author, the title, the, the, the series, the editor, the publisher, the publication date, the list price, the discount rate, the format, the image of the cover page, the key word, the update date, the subject, the currency, the availability status. The data files can be accessed by the customers via the Internet, usually by inputting the customer purchase order number and a password. The information in the data files is periodically updated and the data files are used by the customers and vendor to track the book orders.

Viewing the center of FIG. 1, the vendor sorts the book orders by book sellers (book sellers may be publishers of the specific books or wholesalers). After sorting, the vendor creates aggregated orders and places them with the corresponding book sellers. Still viewing the center of FIG. 1, an aggregated order of three books 1 is placed with Bookseller 1. An aggregated order of two books 2 is placed with Bookseller 2. An aggregated order of three books 3 is placed with Bookseller 3. Accordingly, Bookseller 1 sends three books 1, Bookseller 2 sends two books 2 and Bookseller 3 sends three books 3. This provides savings on shipping costs because Booksellers 1, 2 and 3 ship large quantities of books rather than shipping books individually.

Viewing the bottom of FIG. 1, the books from Booksellers 1, 2 and 3 are received at the Receiving Center established by the vendor. The books are then sorted by the distribution centers corresponding to the book orders, creating bulk shipments. The bulk shipments are then shipped to the corresponding distribution centers. Specifically, a bulk shipment of one book 1 and one book 2 is shipped to Distribution Center Korea. A bulk shipment of two books 1 and one book 3 is shipped to Distribution Center Japan. A bulk shipment one book 2 and three books 3 is shipped to Distribution Center Germany. Once again, this provides savings on shipping costs because books are shipped from the receiving center to the distribution centers in large quantities rather than shipping books individually.

Still viewing the bottom of FIG. 1, the book orders are then shipped from the distribution centers to the individual customers. The book orders from Distribution Center Korea are shipped to Customer 1 and Customer 2. The book orders from Distribution Center Japan are shipped to Customer 3, Customer 4 and Customer 5. The book orders from Distribution Center Germany are shipped to Customer 6, Customer 7 and Customer 8.

The scope of the present invention is defined by the claims that follow.

What is claimed is:

1. A method of processing book orders comprising the steps of:
(a) Establishing a plurality of distribution centers;
(b) Establishing a receiving center;
(c) Receiving book orders from a plurality of customers;
(d) Creating aggregated orders by way of sorting each of said book orders by book sellers corresponding to said aggregated orders;
(e) Placing said aggregated orders with the corresponding book sellers;
(f) Receiving the book orders corresponding to each of said aggregated orders from the corresponding book sellers at the receiving center;
(g) Creating bulk shipments by way of sorting the book orders bound for the same distribution centers; and
(h) Shipping said bulk shipments from the receiving center to the corresponding distribution centers;
(i) Shipping the book orders to the plurality of customers from the distribution centers corresponding to each of the plurality of customers.

2. The method of claim 1 wherein the step of receiving book orders from a plurality of customers is done via a global computer network,

3. The method of claim 1 wherein the step of receiving book orders from a plurality of customers is done via a telephone,

4. The method of claim 1 wherein the step of receiving book orders from a plurality of customers is done via a facsimile,

5. The method of claim 1 further comprising the steps of creating a computer data file for each of said plurality of customers and assigning a customer purchase order number to each of said data files,

6. The method of claim 5 wherein each of said data files further comprises the identifying information about the customer,

7. The method of claim 5 wherein each of said data files further comprises the information about an International Standard Book Number corresponding to each book in the book order,

8. The method of claim 5 wherein each of said data files further comprises the information about the author of the book corresponding to each book in the book order,

9. The method of claim 5 wherein each of said data files further comprises the information about the title of the book corresponding to each book in the book order,

10. The method of claim 5 wherein each of said data files further comprises the information about the subtitle of the book corresponding to each book in the book order,

11. The method of claim 5 wherein each of said data files further comprises the information about the edition of the book corresponding to each book in the book order,

12. The method of claim 5 wherein each of said data files further comprises the information about the series of the book corresponding to each book in the book order,

13. The method of claim 5 wherein each of said data files further comprises the information about the editor of the book corresponding to each book in the book order,

14. The method of claim 5 wherein each of said data files further comprises the information about the publisher of the book corresponding to each book in the book order,

15. The method of claim 5 wherein each of said data files further comprises the information about the publication date of the book corresponding to each book in the book order,

16. The method of claim 5 wherein each of said data files further comprises the information about the list price of the book corresponding to each book in the book order,

17. The method of claim 5 wherein each of said data files further comprises the information about the discount rate of the book corresponding to each book in the book order,

18. The method of claim 5 wherein each of said data files further comprises the information about the format of the book corresponding to each book in the book order,

19. The method of claim 5 wherein each of said data files further comprises the information about the image of the cover page of the book corresponding to each book in the book order,

20. The method of claim 5 wherein each of said data files further comprises the information about the key word of the book corresponding to each book in the book order,

21. The method of claim 5 wherein each of said data files further comprises the information about the update date of the book corresponding to each book in the book order,

22. The method of claim 5 wherein each of said data files further comprises the information about the subject of the book corresponding to each book in the book order,

23. The method of claim 5 wherein each of said data files further comprises the information about the currency of the book corresponding to each book in the book order,

24. The method of claim 5 wherein each of said data files further comprises the information about the availability status of the book order corresponding to each book in the book order,

25. The method of claim 5, further comprising the step of making the information contained in said data files available for access by the corresponding customers via the Internet by way of use of said customer purchase order number,

26. The method of claim 7 wherein the step of creating aggregated orders by way of sorting each of said book orders by book sellers corresponding to said aggregated orders further comprises the use of the International Standard Book Numbers corresponding to each book in the book order,

27. The method of claim 7 wherein the step of creating bulk shipments by way of sorting the book orders bound for the same distribution centers further comprises the step of matching the International Standard Book Numbers corresponding to each book in the book order with the International Standard Book Numbers contained in said data files corresponding to each of said plurality of customers.
